(19) United States
(12) Patent Application Publication
(10) Pub. No.: US 2017/0243310 A1
(43) Pub. Date: Aug. 24, 2017

(54) System For Facilitating And Executing Travel-Related Transactions

(71) Applicant: Mark C. Dawkins, Jacksonville, FL (US)

(72) Inventor: Mark C. Dawkins, Jacksonville, FL (US)

(21) Appl. No.: 15/591,034

(22) Filed: May 9, 2017

Related U.S. Application Data
(63) Continuation-in-part of application No. 13/537,289, filed on Jun. 29, 2012.
Application No. 13/537,289 is a continuation-in-part of application No. 13/771,427, filed on Feb. 20, 2013.

(51) Int. Cl. G06Q 50/14; G06Q 20/10; G06Q 10/02

(52) U.S. Cl. CPC G06Q 50/14; G06Q 10/02; G06Q 20/10

(57) ABSTRACT

The present disclosure relates to methods and systems for facilitating travel preparation and reservations. More specifically, the present disclosure relates to a monitoring system that may monitor travel sites based on input travel parameters, wherein the monitoring may allow a traveler to optimize a trip. The optimization may be based on a plurality of factors, such as price, location, and dates, as non-limiting examples. The present disclosure further relates to an offer system that develops offer terms for travel providers to extend to travelers, wherein offer terms may vary based on a plurality of factors, such as trends, sales, or demand, as non-limiting examples.

### CROSS-REFERENCE TO RELATED APPLICATION

This application claims priority to and the full benefit of U.S. Non-provisional patent application Ser. Nos. 13/537,289 (filed Jun. 29, 2012, and titled “SYSTEM FOR EXECUTING TRAVEL RELATED TRANSACTIONS”) and 13/771,427 (filed Feb. 20, 2013, and titled “SYSTEM FOR FACILITATING TRAVEL RELATED TRANSACTIONS”), the entire contents of which are incorporated herein by reference.

### BACKGROUND OF THE DISCLOSURE

Travel has been a core element of humanity since its inception. Out of necessity, communities would follow the migration patterns of animals they hunted, when there were no longer natural resources that were essential to sustain a population, or when they were forced out of a location as a result of battle or war. As humanity settled into more permanent communities, the concept of travel was still embedded in daily existence. Merchants became an essential part of society, bringing supplies to communities that did not have the means to travel while also spreading culture to otherwise isolated populations. During the Middle Ages, certain communities would go on pilgrimages to visit a shrine or location important to their beliefs. The Industrial Revolution spurred innovation, making it easier for people to travel with the advent of a railroad infrastructure.

As travel continued to become less dangerous and more accessible, it remained a core tenet of society as leisure travel became more of a tangible possibility. As a result, more people were able to travel who may not have been able to before. With the development of trains, automobiles, boats, and airplanes, boundaries between counties became virtually non-existent.

People are now able to travel for a variety of reasons, such as for business, recreation, commuting, or vacationing. Some travel to learn about other cultures, while others travel to enjoy themselves with others or to visit family. As travel became more sophisticated, so too did the hospitality and tourism industry. Functional necessities like higher capacity hotels and more restaurant availability came about to meet demand, while luxury and recreational activities started to develop at popular destinations.

At some point during this proliferation, travel agencies were created to facilitate ease of access and booking. Through one agency, a traveler had access to various resources to plan their trip, such as an itinerary, accommodations, and, sometimes, first-hand knowledge and advice. Airlines also began to develop methods to automate the booking process, which resulted in the Reservisor and the Magnetronic Reservisor. These electromechanical computer systems automated storing seat inventory, with the Magnetronic Reservisor capable of storing information for up to 1,000 flights 10 days into the future. The Reserwriter was then created to record passenger information after a sale was made. These devices all still required manual input.

As a result, the Semi-automated Business Research Environment (SABRE) was developed, which allowed for automation of booking reservations. At the time, this allowed American Airlines to handle airline reservations in a high growth industry, where passenger volumes were growing at an enormous scale. Global Distribution Systems (GDS) like Sabre, Amadeus, and Galileo now form the backbone of the travel agent and reservation industry.

Though GDS is used to facilitate booking reservations throughout the travel industry, there is still a need to further streamline and facilitate the process for consumers. While the proliferation of the internet has resulted in fare aggregators, travel metasearch engines, and booking engines, companies are still developing ways to facilitate the user experience, decrease pricing, and increase accessibility and ease of use. The travel industry as a whole is still affected by constant price fluctuations caused by supply and demand, which in turn affects a consumer's ability to purchase tickets.

### SUMMARY OF THE DISCLOSURE

What is needed, therefore, is a system to allow a user to input a set of desired parameters, such as a travel date, desired pricing, destination, and number of seats, and have a server continuously monitor and scan other servers for this information. Once the conditions are met, the system will then make a reservation and forward payment on behalf of the user. This cuts down on the time a user has to be constantly watching for travel developments and gives them piece of mind that, once their criteria is met, they will get a ticket. Coupled with predictive data aggregated over time, the system itself may identify when it is most likely that a purchase might be made and advise a user accordingly so that they can anticipate when a charge would occur.

Alternatively, a user may enter a bid into a system, which will then communicate directly to vendors. A pool of vendors would have access to these bids as they come in and may communicate privately with the user. A vendor, looking at their availability through their own servers, may then accept the user's offer or issue a counteroffer, which the user may determine whether to accept. This system allows vendors, who may have availability on particular dates, to accommodate users without revealing a discounted price to the public. A vendor may also be better able to accommodate a user's criteria request by reviewing their own availability and countering an original offer with something that would be satisfactory to both parties.

The present disclosure relates to a system for executing travel transactions, wherein the system may comprise a traveler server configured to receive and store at least one traveler profile. In some aspects, each traveler profile may comprise at least one destination; at least one travel type; travel parameters that may comprise at least one travel date and duration; and price parameters with maximum price limits for one or more of the at least one travel type, travel parameters, and the at least one destination. In some aspects, the traveler profile may comprise traveler information with traveler identifying data.

The system may comprise a monitoring server configured to access the traveler server and a plurality of remote servers hosted by one or more travel vendors, where the one or more travel vendors offer at least a portion of the traveler profile. The system may periodically monitor the plurality of remote servers for availability data related to at least the portion of the traveler profile. The system may compare the price parameters to vendor pricing associated with the availability data related to at least the portion of the traveler profile. The system may identify qualified availability data paired with a qualified travel vendor and purchase information, wherein the vendor pricing associated with qualified availability data is priced equal to or below the price parameters related to at least the portion of the traveler profile. The system may store qualified availability data.

In some aspects, a traveler profile may comprise rank criteria, where the rank criteria prioritizes one or more of the plurality of destinations, at least one travel type, price parameters, and travel parameters. The monitoring server may be further configured to compare identified qualified availability data using rank criteria, where a comparison determines a best qualified availability data. In some embodiments, the travel vendor may comprise a travel aggregator. The system may comprise a ticket buying service that may operate one or more of the traveler server, the monitoring server, and the purchase server. In some embodiments, the traveler server may comprise purchaser information with purchaser identifying data and purchase authorization data. The system further may comprise a purchase server configured to access the traveler server and a monitoring server.

In some implementations, the system may execute purchase of the best qualified availability data by transmitting purchaser information to the qualified travel vendor. The system may transmit confirmation to one or more of the traveler server, monitoring server, purchaser, or traveler. In some embodiments, the traveler profile may comprise destination activities. In some aspects, the monitoring server may periodically monitor the plurality of remote servers. The monitoring server may be further configured to monitor travel price trends associated with at least one traveler profile.

In some implementations, the frequency of the periodic monitoring may be based at least in part on a travel price trend associated with at least one traveler profile. A traveler profile may comprise a monitoring parameter associated with one or more destination, travel type, and travel parameters, wherein the monitoring parameter may determine the frequency of the periodic monitoring for the one or more destination, travel type, and travel parameters. In some aspects, the travel provider server may be configured to evaluate one or more sales trends, projected demand, and excess supply related to target criteria. The travel provider server may be configured to access external servers, which may comprise one or more vendor monitors, trend monitors, and traveler monitors.

In some aspects, the system may comprise a search server configured to receive at least one travel parameter search input; access the travel provider server; retrieve the conditional offer from the travel provider server; compare the at least one travel parameter search input to the conditional offer, where the comparison determines whether the conditional offer may comprise the at least one travel parameter search input; return results of the comparison, where the returned results comprise the conditional offer if the conditional offer may comprise the at least one travel parameter search input. The system may comprise a plurality of travel provider servers, where each of the plurality of provider servers may be configured to set a plurality of conditional offers. The system may comprise a purchase server, where the purchase server is configured to transfer funds from a first account belonging to one or more of the target travelers to a second account belonging to the travel provider through an electronic transfer system.

In some embodiments, the purchase server may be configured to transfer a document confirming purchase of the target travel type to the one or more of the target purchasers, wherein the transmission of the conditional offer may occur within the offer duration and the conditional offer expires after the offer duration. In some aspects, the traveler profile may comprise rank criteria, wherein the rank criteria prioritizes one or more of the plurality of destinations, at least one travel type, price parameters, and travel parameters, and the travel provider server may be further configured to compare offer travel parameters to traveler profile using rank criteria. The offer travel parameters may comprise a rank threshold for one or more the travel type or destination, wherein target traveler profiles further comprise rank criteria equal to or lower than the rank threshold.

The present disclosure relates to a system for executing travel transactions, wherein the system may comprise a travel provider server configured to access a traveler server. In some aspects, the traveler server may be configured to receive and store a plurality of traveler profiles, where each traveler profile may comprise at least one destination; at least one travel type; traveler information, such as traveler identifying data; travel parameters, such as travel date and duration; price parameters, such as maximum price limits for one or more of the at least one travel type, travel parameters, and the at least one destination.

In some embodiments, the system may filter traveler profiles by at least one offered travel type, wherein the travel provider server may isolate relevant travel profiles, which may comprise at least one offered travel type offered by the travel provider. The system may set a conditional offer for purchase of at least one offered travel type within offer travel parameters, which may comprise an offer price and an offer duration. The system may identify target traveler profiles, which may comprise the offered travel type within the offer travel parameters and price bids equal to or greater than the offer price. The system may transmit the conditional offer to target travelers associated with target traveler profiles.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary monitoring optimizer database system.

FIG. 2 illustrates an exemplary traveler profile.

FIG. 3 illustrates an exemplary interactive local destination display.

FIG. 4 illustrates an exemplary interactive destination display.

FIG. 5 illustrates an exemplary interactive travel planning interface.

FIG. 6 illustrates an exemplary historical price visualization.

FIG. 7 illustrates an exemplary process flowchart for sorting travel parameters, monitoring servers, and purchasing results.

FIG. 8 illustrates an exemplary request monitor system.

FIG. 9 illustrates an monitoring and processing system.

FIG. 10 illustrates an exemplary process flowchart for receiving and conveying offers.

FIG. 11 illustrates apparatus that may be used to implement aspects of the present disclosure including executable software.

FIG. 12 illustrates apparatus that may be used to implement aspects of the present disclosure including executable software.

### DETAILED DESCRIPTION

The present disclosure provides generally for systems and related methods where one or both a user and vendor may set parameters to have a continuous search of servers to retrieve results and take actions based on those parameters. According to the present disclosure, this continuous search is set by a user to either bring them results they can then make a decision on or so that the system itself can reserve or take action on their behalf. The system determines user intent and priorities using parameters provided by the user or the vendor. The system then takes the appropriate action as set by the user. The system may pull from various sources or servers to retrieve or present information to the user.

In the following sections, detailed descriptions of examples and methods of the disclosure will be given. The description of both preferred and alternative examples though thorough are exemplary only, and it is understood that to those skilled in the art variations, modifications, and alterations may be apparent. It is therefore to be understood that the examples do not limit the broadness of the aspects of the underlying disclosure as defined by the claims.

### Glossary

Activity: as used herein, refers to something affording amusement, entertainment, or enjoyment in some fashion, including, but not limited to, events, attractions, diversions, or venues.
Travel Aggregator: as used herein, refers to a mechanism that may directly populate events into the system. Travel aggregators may access, monitor, or analyze server information to populate the travel system. In some embodiments, a travel aggregator may comprise an automated mechanism. In some implementations, a travel aggregator may have an individual providing quality assurance on the data retrieved by the travel aggregator. In some aspects, an individual may be a travel aggregator, manually retrieving and implementing the availability of information received.

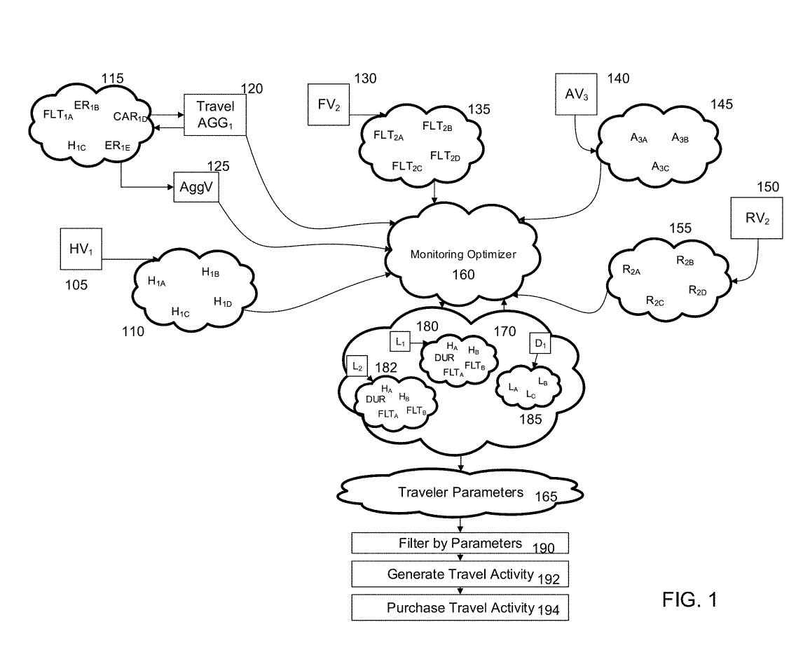

Referring now to FIG. 1, an exemplary monitoring optimizer database 160 system is illustrated. In some embodiments, a vendor 105, 130, 140, 150 may create available travel data 110, 135, 145, 155. In some implementations, a vendor 105, 130, 140, 150 may feed this availability data directly to the monitoring optimizer database 160. In some aspects, the monitoring optimizer database 160 may monitor vendor 105, 130, 140, 150 servers for vendor availability data 110, 135, 145, 155 and aggregate the vendor availability data 110 within the monitoring optimizer database 160.

In some aspects, vendors 105, 130, 140, 150 may provide a specific travel service, such as a hotel vendor 105, flight vendor 130, attraction vendor 140, and rental vendor 150, and the monitoring optimizer database 160 may access specific available travel data 110, 135, 145, 155 from each respective vendor 105, 130, 140, 150. For example, the monitoring optimizer database 160 may access available rental data 155 from a rental vendor 150, such as available vehicles. The monitoring optimizer database 160 may access available attraction data 145 from an attraction vendor 140, such as destination-related attractions or general vacation attractions. For example, destination-related activities may include skiing, sky diving, or tours. The monitoring optimizer database 160 may access available flight data 135 from a flight vendor 130, such as an airline. The monitoring optimizer database 160 may access available hotel data 110 from a hotel vendor 105, such as a hotel chain or hotel group of chains, which may be owned by the same company.

In some embodiments, a travel aggregator 120 may pull availability information data 115 into the monitoring optimizer database 160 from vendors 105, 130, 140, 150 or verified or approved third-party sources. For example, these sources may include previously unsold quantities or historically available items. In some implementations, a travel aggregator 120 may aggregate availability information data 115 from external servers. For example, a travel aggregator 120 may comprise a third-party service that collects and presents a dynamic list of travel options for a particular location. As another example, a travel aggregator 120 may be a local travel center, wherein the travel center may have information about hotel availability, transportation availability, attraction availability, or flight availability.

In some implementations, an aggregator vendor 125 may retrieve or access availability data that previously existed and feed it into the monitoring optimizer database 160.

For example, an aggregator vendor 125 may have affiliates, subsidiaries, or third party relationships and would like to have aggregated availability data 115 be part of the monitoring optimizer database 160.

In some embodiments, the monitoring optimizer database 160 may monitor servers for activity data to populate its systems. In some implementations, a travel aggregator 120 may monitor servers to pull and create availability data to feed into the monitoring optimizer database 160. In some aspects, a travel aggregator 120 may populate the monitoring optimizer database 160 with current availability information. In some embodiments, aggregated availability data 115 may flow directly to a travel aggregator 120 who may then input availability data into the monitoring optimizer database 160. In some implementations, a user may prompt the monitoring optimizer database 160 for availability data information.

At 190, travel parameters may be filtered. At 192, a travel activity may be generated. At 194, a travel activity may be purchased. In some embodiments, travel parameters may be filtered by a variety of factors. In some implementations, travel parameters may be set by a traveler profile 170. In some aspects, a traveler may input a variety of parameters, which may include location, date, attraction, price, duration, hotel, flight, cruise, rentals, as non-limiting examples. In some embodiments, these parameters may be considered part of a traveler profile 170.

A travel profile 170 may include sub-profiles 180, 182, 185 based on specific parameters. For example, a first location sub-profile 180 may include travel preferences for a first location, such as hotels, duration, or flights, and a second location sub-profile 182 may include travel preferences for a second location, such as hotels, duration, or flights. A date sub-profile 185 may include travel preferences for travel during a specific time period. For example, a traveler may want to travel during a spring break and may be flexible as to the destination.

In some implementations, the traveler parameters 165 may interact with the monitoring optimizer database 160 to filter to the appropriate results. In some aspects, the monitoring optimizer database 160 may search other servers to secure or find the traveler parameters 165.

In some embodiments, the monitoring optimizer database 160 may have information matching the traveler parameters 165 within its database. In some implementations, the monitoring optimizer database 160 may then display this result to the traveler. In some aspects, a traveler may edit or amend these results as needed. In some embodiments, a traveler may have settings to immediately or instantly purchase the travel activity if it falls within the traveler parameters 165. In some implementations, a traveler may have settings to confirm the purchase before it is made by the system.

As an illustrative example, a traveler may input that they would like tickets to a ski lodge in February for a set price. The traveler may say that they would like to fly with a particular airline at a certain time for a certain price. In this example, the travel parameters would be the time range for the flight, the price for the flight, the destination, their date range for the trip, the airline, and the quantity of tickets. The monitoring optimizer database 160 would then pick up this data from the traveler parameters 165 to then search other servers to bring back results within this range. If these results are not available at the time of the initial search, the monitoring optimizer database 160 will continue to search on the traveler's behalf until those results are reached. In some embodiments, a traveler may set a limit for how long the monitoring optimizer database 160 will perform the search. For example, the traveler may set a cut-off time frame of up to a month before the desired travel plans. In some aspects, a traveler may create travel parameters that change or create different reference points over time. For example, a traveler may be willing to pay $300 for a flight from February to May, $350 from June to August, and $400 from September to October.

In some implementations, the monitoring optimizer database 160 may search on an intermittent basis, such as once an hour or once a day. In some aspects, a traveler may set when the frequency with which the monitoring optimizer database 160 performs its search to match the travel parameters 165. In some embodiments, the monitoring optimizer database 160 may self-adjust its search frequency depending on a variety of factors, such as historical popularity of the parameters, the likelihood of success, historical data on when the prices may fluctuate, how often the traveler checks in for results or progress, or recent fluctuations in pricing or availability.

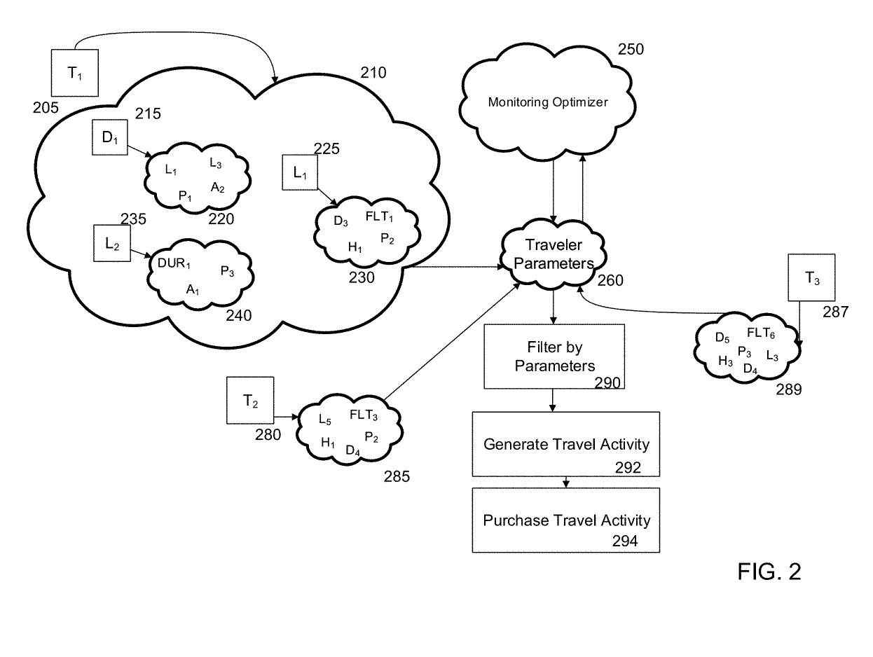

Referring now to FIG. 2, an optimizer database 250 system with exemplary traveler profiles 210, 285, 289 associated with travelers 205, 280, 287 is illustrated. In some embodiments, a first traveler 205 may be associated with a first traveler profile 210 that may include multiple profile search queries 215, 225, 235. In some implementations, each profile search query 215, 225, 235 may have specific result requests 220, 230, 240. In some aspects, a traveler may create multiple profile search queries 215, 225, 235 with differing result requests 220, 230, 240.

In some embodiments, a traveler may have overlapping result requests 220, 230, 240 within a profile search query 215, 225, 235. In some implementations, a traveler may save a profile search query 215, 225, 235 to create a set of travel parameters 260. In some aspects, the travel parameters 260 may pull from traveler profiles 210, 285, 289 and access a monitoring optimizer database 250 based on these parameters. In some implementations, the monitoring optimizer database 250 may interact with servers or other sources as described above in FIG. 1.

In some embodiments, a traveler may customize each search query 215, 225, 235. For example, in a date search query 215, a traveler may input date result requests 220 specifying two separate locations, a price, and an attraction with a set date range. In a first location search query 225, a traveler may input first location result requests 230 specifying a date, a flight, a hotel, and a price within a location. In a second location search query 235, a traveler may input second location result requests 240 specifying duration of the trip, a price, and an attraction within a second location.

In some implementations, this first exemplary traveler profile 210, created by the first traveler 205, may constitute traveler parameters 260 that coordinate with the monitoring optimizer database 250. In some embodiments, the monitoring optimizer database 250 system may comprise a plurality of traveler profiles 210, 285, 289. A first traveler 205 may comprise a complex first traveler profile 210. A second traveler 280 may be associated with a second traveler profile 285, and a third traveler 287 may be associated with a third traveler profile 289. The second traveler profile 285 and third traveler profile 289 may be simple, such as for a single location or date. In some aspects, result requests may include location, date, attraction, price, duration, hotel, flight, layover, or rental vehicle options. At 290, travel parameters may be filtered. At 292, a travel activity may be generated. At 294, a travel activity may be purchased.

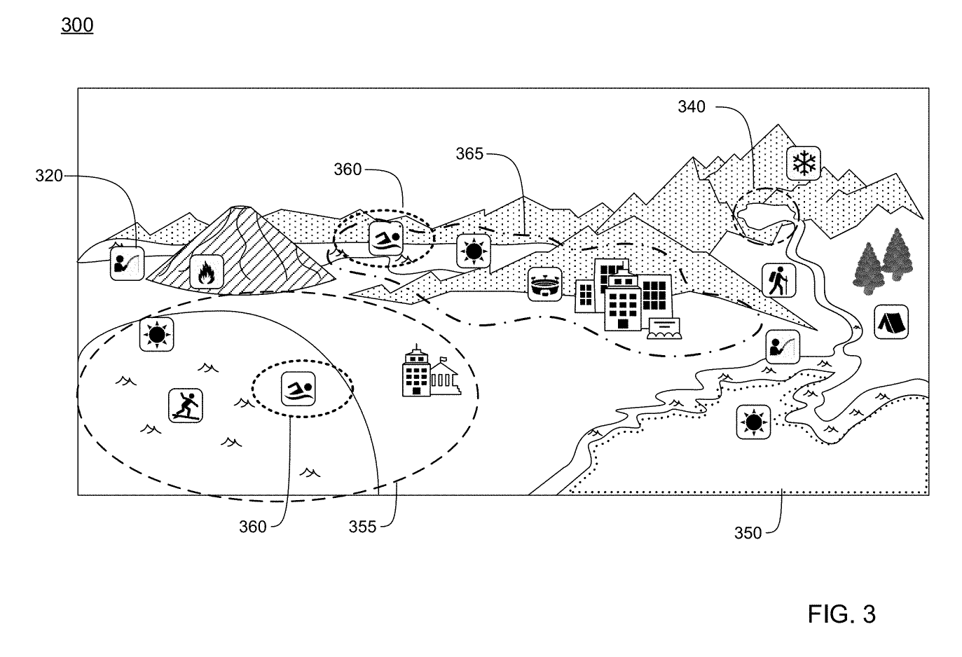

Referring now to FIG. 3, an exemplary interactive local destination display 300 is illustrated. In some embodiments, an interactive local destination display 300 may contain a visualization of the surrounding activities available in a particular area. In some implementations, a traveler may click on an activity icon 320 for more information about an activity. In some aspects, a traveler may click on an activity icon 320 to add the activity to a traveler profile or traveler parameters. In some embodiments, a traveler may click on an activity icon 320 to access similar activities to those that the traveler clicked on. For example, if a traveler clicks on an activity such as camping, there may by activities like hiking or backpacking nearby.

In some implementations, a traveler may click on an activity icon 320 that may have custom functionality or utility. In some aspects, an elevated area 340 may be selected based on its vicinity to a landform. For example, it may be important to ski near a place with high altitude and snow. In some embodiments, a landform 350 may be selected based on the landform itself. For example, a traveler may choose a destination based on how suitable it might be for camping or to go on a nature hike. In some implementations, a regional selection 355 may highlight nearby locales. For example, clicking on a beach may show a nearby city where a traveler may choose to stay.

In some embodiments, clicking a swimming icon 360 may automatically display similar activities within the same area. For example, by clicking on a swimming icon 360, a traveler may see all swimming activities available within the destination. In some implementations, a traveler may customize how similar the activity must be to automatically display. For example, a traveler may only want to have swimming activities appear within the destination as opposed to water-related activities such as scuba diving, surfing, or jet-skiing.

In some aspects, a traveler may create a custom area 365 and customize an area to see what other activities may be available around there. For example, a traveler may set a 10 mile perimeter around an activity they are interested in doing to see what else is in the area. In some embodiments, clicking a custom area 365 may show a custom drawn area created by an affiliate or travel aggregator. In some implementations, clicking the custom area 365 may suggest other activities to a traveler.

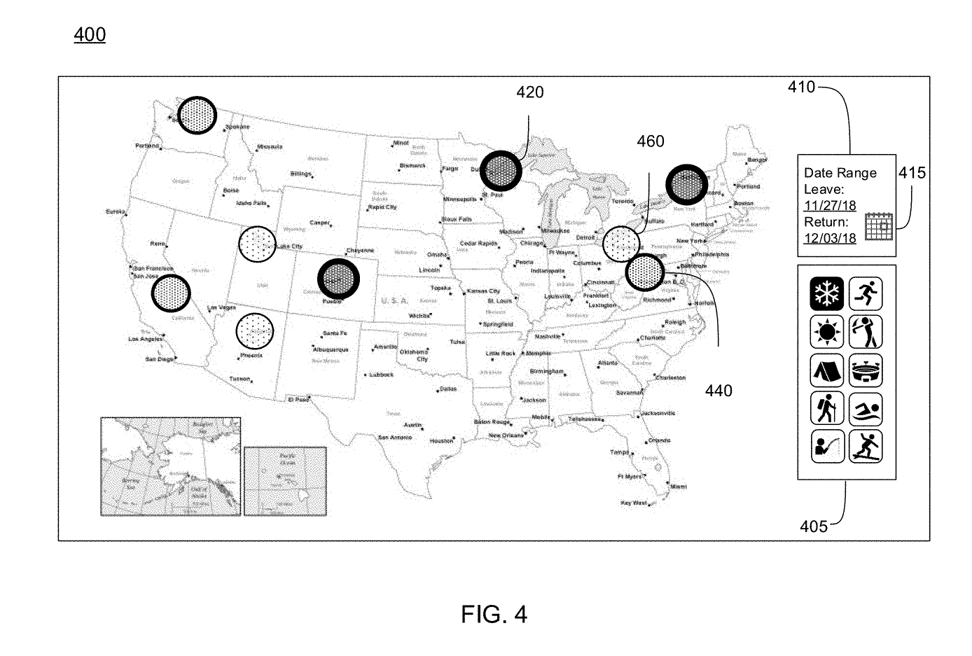

Referring now to FIG. 4, an exemplary interactive destination display 400 is illustrated. In some embodiments, an interactive destination display 400 may contain a visualization of the surrounding activities available within a large area, such as a country or a state. In some implementations, a traveler may zoom in to a particular area for more information about the activities available there. In some aspects, a traveler may select a starting point on the interactive destination display 400 to begin or end their travels. In some embodiments, a traveler may select an itinerary or destination based on their desired activities. In some implementations, a destination may display activities when a traveler clicks on that destination.

In some aspects, a destination parameter icon bar 405 may filter appropriate locations. In some embodiments, a traveler may filter available destinations by clicking on desired activities. In some implementations, a traveler may input a custom travel date range 410. In some aspects, a traveler may input or click a calendar view icon 415 to switch the custom travel date range 410 to a different view type. In some aspects, a traveler may rank destination points 420, 440, 460, which may allow the monitor optimizer to prioritize the travel options, and the appearance of the destination points 420, 440, 460 may indicate the rank. For example, the preferred snow destinations 420 may be Colorado, Minnesota, and New York; the second ranked snow destinations 440 may be Washington, Pennsylvania, and California; and the third ranked snow destinations 460 may be Utah, Arizona, and Ohio.

In some embodiments, a traveler may use the interactive destination display 400 to input desired destination points 420, 440, 460. In some implementations, a traveler may rank desired destination points 420, 440, 460 in order of priority. In some aspects, a traveler may filter desired destination points 420, 440, 460 on an activity available at each destination. In some implementations, a traveler may have multiple levels of priority with mixed activities for each desired destination point 420, 440, 460. For example, a traveler may prioritize California for surfing over Nebraska for a national park excursion. If a traveler's parameters are not met for the California trip, they may have a trip to Nebraska booked instead.

In some embodiments, a traveler may link desired destination points 420, 440, 460 and create an itinerary to visit those destinations. In some implementations, a linked destination point 420, 440, 460 may have separate travel date ranges for the traveler. In some aspects, a traveler may leave the travel date range option open for each linked destination point 420, 440, 460 so that the system may schedule trips based on availability or other parameters. For example, a traveler may want to ski in Park City, Utah; Aspen, Colorado; and British Columbia, Canada. A traveler may input these destinations within a date range. Instead of setting a priority as to which location the traveler would prefer to go to within parameters set by the traveler, the traveler instead may link these locations. The system may then schedule two out of three trips within the date range if they satisfy other parameters set by the traveler.

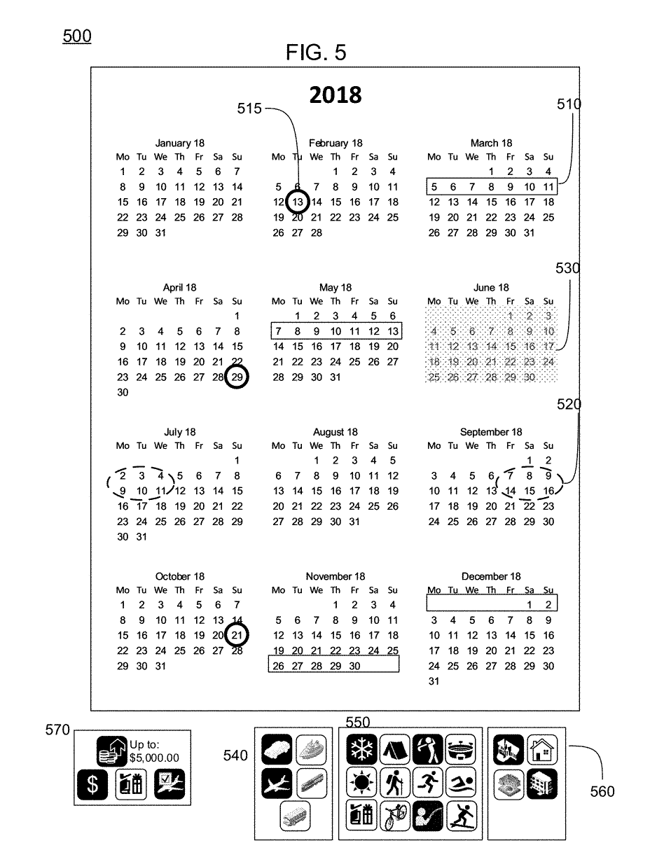

Referring now to FIG. 5, an exemplary interactive travel planning interface 500 is illustrated. In some embodiments, the interactive travel planning interface 500 may have a calendar view. In some implementations, the interactive travel planning interface 500 may divide its calendar view by months, weeks, or days. In some aspects, the interactive travel planning interface 500 may filter its appearance based on traveler input availability.

In some embodiments, the interactive travel planning interface 500 may display an exact travel date range 510. In some implementations, the interactive travel planning interface 500 may highlight a specific “book by” date notification 515. In some aspects, the book by date notification 515 may be set by the traveler to inform the system the latest or earliest time to purchase travel. In some embodiments, the book by date notification 515 may be set by a vendor. In some implementations, a book by date notification 515 may require further action, such as confirming a purchase or to continue to monitor servers for traveler parameters. In some aspects, a traveler may set a flexible date range 520. For example, a traveler may select a range of dates within a span of two weeks without overlap, such as Monday to Wednesday on week 1 and Thursday to Saturday on Week 2. As another example, a traveler may select three days on either side of two weeks to mark their availability. In some embodiments, the system may then search for availability within either of these date ranges for a match for the user. In some implementations, a traveler may prioritize one set of dates over another. In some aspects, a traveler may choose one result over another if results return for any set of dates.

In some embodiments, a traveler may select a general date range 530. In some embodiments, a traveler may choose a date tied to specific travel parameters, such as a specific destination, a specific activity, a specific price range, or a specific airline or transportation vendor, by way of non-limiting examples. In some implementations, a traveler may specify a vendor with which they hold a rewards or perks account to use those points for a reservation. In some aspects, a traveler may rank vacation profiles to aid the system in prioritizing which one would be booked first. In some embodiments, a traveler may customize travel parameters to make a purchase if a price drops below a certain number or number range. In some implementations, a traveler may customize travel parameters to make a purchase if travel plans may be booked by a specific date or date range.

In some aspects, the interactive travel planning interface 500 may have transportation method filters 540. In some embodiments, the interactive travel planning interface 500 may have activity icons 550. In some implementations, a traveler may select the activities they would like in their search. In some aspects, a traveler may filter results by activities available. In some embodiments, a traveler may select activity icons 550 to designate unwanted activities. In some implementations, a traveler may select relevant activity icons 550 to designate what is required or a priority. In some aspects, the interactive travel planning interface 500 may have lodging icons 560. In some embodiments, the lodging icons 560 may include motels, hotels, extended stay options, short-term lodging, timeshares, condominiums, apartments, cabins, bed and breakfasts, as non-limiting examples.

In some embodiments, the interactive travel planning interface 500 may have automated or automatic payment options 570. In some implementations, a traveler may input a range for their travel plans. In some aspects, payment options may include money, shopping points, or airline points, as non-limiting examples. In some embodiments, a traveler may set their options to only make a purchase if they earn reward or loyalty points from that purchase.

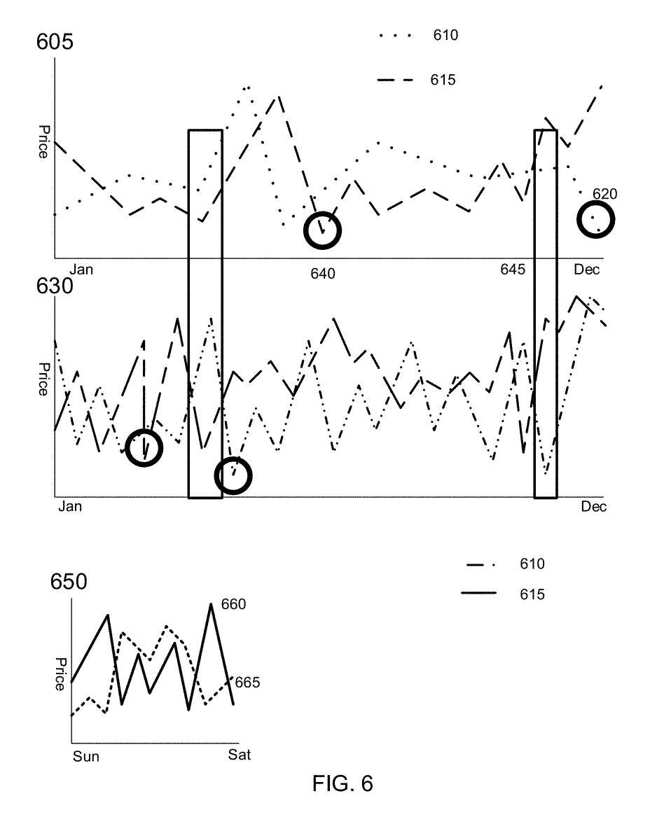

Referring now to FIG. 6, an exemplary historical price visualization is illustrated. In some embodiments, an annual flight price index 605 may display price trends for flights. In some implementations, the annual flight price index 605 may indicate the relationship of flight pricing compared to those of other industries, such as hotels, as a non-limiting example. In some aspects, the annual flight price index 605 may inform the monitoring optimizer how often monitoring could occur based on its data. In some embodiments, the annual flight price index 605 may include historical data from numerous years that may inform the monitoring optimizer. In some implementations, index data may help the monitoring optimizer predict when prices may be likely to go in flux.

In some aspects, the annual flight price index 605 may include one or both a purchase date price data line 610 and a travel date price data line 615. In some embodiments, a data line may indicate a purchase date low point 620 specific to that data line, a travel date low point 640, or a correlation low point data line 645 that may sync up with another industry price index. In some implementations, an annual hotel price index 630 may display price trends for hotels.

In some aspects, a weekly trend index 650 may display historical data based on a category. For example, the weekly trend index 650 may show weekly trends for hotels in a particular city. In some embodiments, the weekly trend index 650 may inform the monitoring optimizer to improve its determination as to when and how often rates may be monitored. In some implementations, the weekly trend index 650 may inform the monitoring optimizer with information about each relevant city. In some aspects, a tourist weekly trend index 660 may show a price spike to indicate that a tourist-frequented location or a weekend visit may have higher prices for a hotel. For example, three-star hotels may trend at a higher price at certain times over four-star hotels based on promotions they run during certain times. In some embodiments, a weekly business trend index 665 may show a price spike to indicate a weekday stay may have higher prices if a location is popular in the business community.

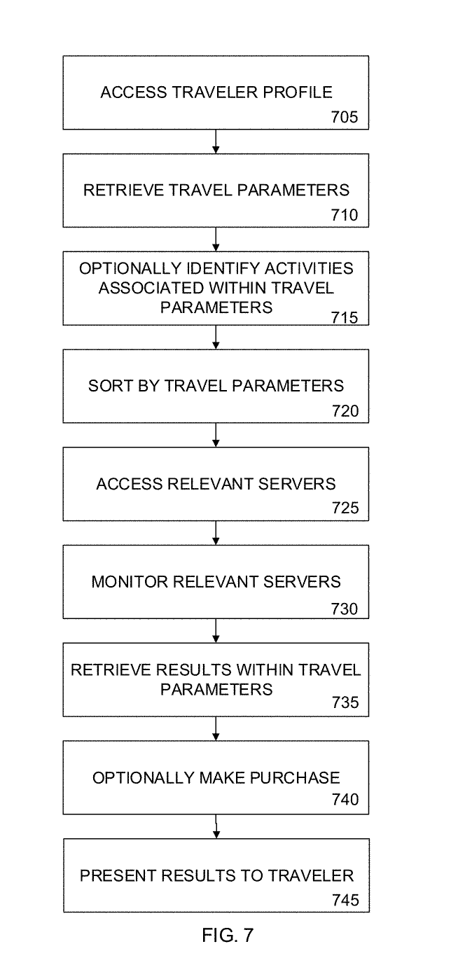

Referring now to FIG. 7, an exemplary process flowchart for sorting travel parameters, monitoring servers, and purchasing results is illustrated. At 705, a traveler profile may be accessed. At 710, travel parameters may be retrieved. In some embodiments, at 715, activities associated within travel parameters may be identified. At 720, travel parameters may be sorted. At 725, relevant servers may be accessed. At 730, relevant servers may be monitored. At 735, results within travel parameters may be retrieved. In some implementations, at 740, a purchase may be made. At 745, results may be presented to traveler.

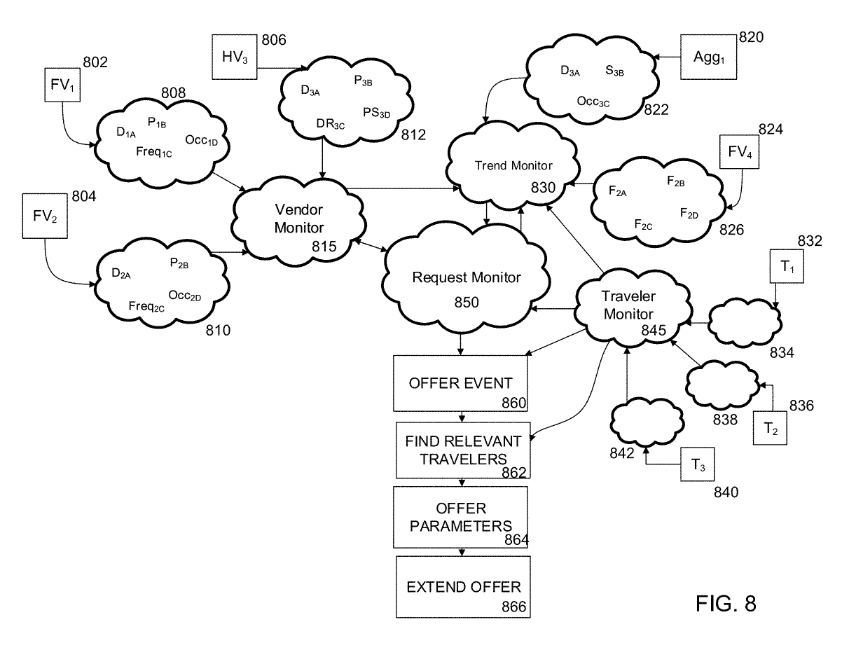

Referring now to FIG. 8, an exemplary request monitor 850 system is illustrated. In some embodiments, a vendor 802, 804, 806 may create availability data 808, 810, 812. In some implementations, these vendors 802, 804, 806 may be in the same or different industries, such as a first flight vendor 802 with first flight availability data 808; a second flight vendor 804 with second flight availability data 810; and a hotel vendor 806 with hotel availability data 812. In some aspects, a vendor monitor 815 may pull this availability data 808, 810, 812 from vendors 802, 804, 806. In some embodiments, a vendor 802, 804, 806 may push this availability data 808, 810, 812 to the vendor monitor 815. In some implementations, the availability data 808, 810, 812 may be broken into separate categories. For example, these categories may include occupancy; availability; price; price range; date; date range; frequency of the activity, such as a flight; historical data regarding sell-through rates; as non-limiting examples.

In some aspects, the vendor monitor 815 may share or push availability data 808, 810, 812 to a request monitor 850. In some embodiments, the vendor monitor 815 may sort, classify, or organize availability data before sending it to the request monitor 850. In some implementations, the request monitor 850 and the vendor monitor 815 may be in constant or periodic contact with one another. In some aspects, the request monitor 850 may constantly or periodically inspect the vendor monitor 815 activity.

In some embodiments, an aggregator 820 may have available activity data stored in its respective systems or servers. In some implementations, an aggregator 820 may have accumulated historical information 822 about availability, occupancy, sell-through rates, or likelihood of sale, as non-limiting examples. In some aspects, an aggregator 820 may have data spanning years of transactions. In some embodiments, an aggregator 820 may push or feed this data or information to a trend monitor 830. In some implementations, a trend monitor 830 may access or pull this data or information from an aggregator 820.

In some aspects, a third flight vendor 824 may create availability data 826. In some embodiments, the trend monitor 830 may analyze this availability data 826 across several other vendors to determine what is currently available, what is selling, and what remains available over a period of time. In some implementations, the trend monitor 830 may also analyze this availability data 826 across several other vendors to project what may remain available in the future based on current and historical availability, alongside other factors such as frequency of offerings, quantity, type of availability, industry, as non-limiting examples.

In some aspects, the trend monitor 830 may push or share this information with the request monitor 850. In some embodiments, the trend monitor 830 may sort, classify, or organize availability data before sending it to the request monitor 850. In some aspects, the trend monitor 830 may convert raw information received into an index noting availability or historical data, as non-limiting examples. In some embodiments, the trend monitor 830 may receive information from the vendor monitor 815, the trend monitor 830, and the travel monitor 845 to analyze or convert to an index or summary. In some implementations, the request monitor 850 and the vendor monitor 815, the trend monitor 830, and the travel monitor 845 may be in regular contact with one another. In some aspects, the request monitor 850 may regularly inspect the vendor monitor 815, the trend monitor 830, and the travel monitor 845 activity.

In some embodiments, travelers 832, 836, 840 may create traveler profiles 834, 838, 842 such as described in FIG. 2. In some implementations, a traveler profile 834, 838, 842 may contain traveler parameters or multiple profiles, as described in FIG. 2. In some aspects, a traveler monitor 845 may receive or access the traveler profiles 834, 838, 842. In some implementations, the traveler monitor 845 may sort or organize the traveler profiles 834, 838, 842. In some embodiments, the traveler monitor may send raw traveler profile information to the trend monitor 830. In some implementations, the trend monitor 830 may convert this raw information into an index accessible by the request monitor 850. In some aspects, the trend monitor 830 may receive information from the vendor monitor 815, the traveler monitor 845, and other sources to predict future availability information.

In some embodiments, the request monitor 850 may access the vendor monitor 815, the trend monitor 830, and the traveler monitor 845 together or individually. In some implementations, the request monitor 850 may regularly receive information from the other monitors 815, 830, 845. In some aspects, the request monitor 850 may receive information from the other monitors 815, 830, 845 in real-time. In some embodiments, the request monitor 850 may facilitate communications between the travelers 832, 836, 840 and the vendors 802, 804, 806, 824. In some implementations, the request monitor 850 may initiate transactions between the travelers 832, 836, 840 and the vendors 802, 804, 806, 824. In some aspects, the request monitor 850 may analyze available information from other sources, including but not limited to the monitors 815, 830, 845 to provide predictive or historical data for a transaction.

At 860, an event is offered. At 862, relevant travelers may be found. At 864, offer parameters may be created. In some implementations, an offer parameter may include price, time frame, flight, duration of the offer, or combinations thereof as non-limiting examples. At 866, the offer may be extended to one or more travelers. In some embodiments, a vendor may extend an offer to a traveler once they fall within certain parameters. In some implementations, a traveler may initiate an offer.

For example, a traveler may wish to pay a certain amount for a flight on a certain date. In some aspects, a vendor may determine whether to extend an offer based on a variety of factors, such as seat availability on a flight, history of low sales, frequency a flight is offered, whether any sales have been made within a certain time period, whether the destination is a seasonal location, or whether there is a history of a price decrease over time, as non-limiting examples. In some embodiments, the request monitor 850 may initiate the offer event 860 by matching the traveler profiles 834, 838, 842 to what vendors 802, 804, 806, 824 may have available.

In some embodiments, a request monitor 850 may be associated with a particular offeror vendor, wherein the offeror vendor may have access data from the vendor monitor 815, trend monitor 830, and traveler monitor 845. The accessible data may include relevant public information from all monitors 815, 830, 845 and private data from the offeror vendor, such as internal records. An offeror vendor may utilize external data to dynamically create offers that account for external supply and demand.

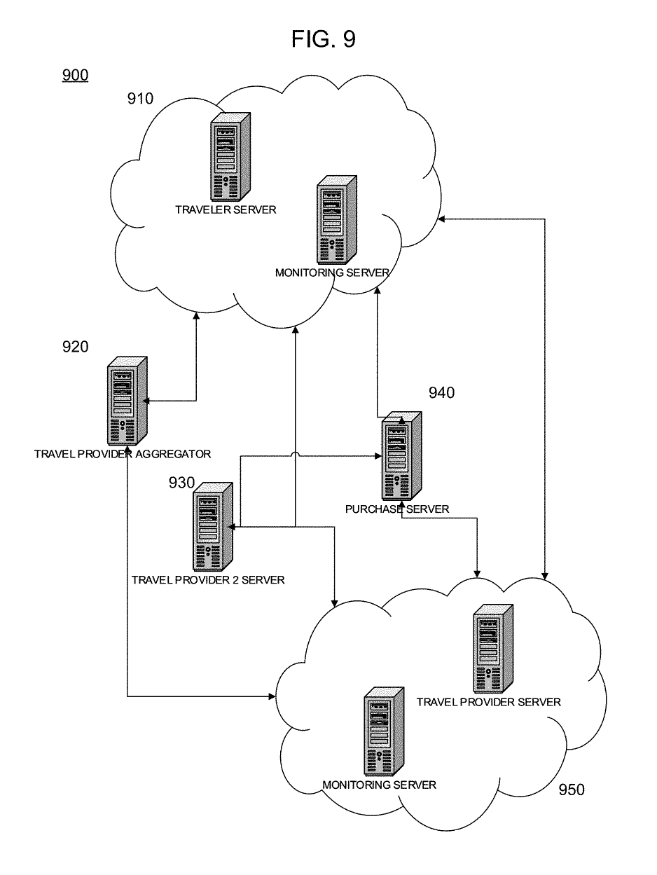

Referring now to FIG. 9, an exemplary monitoring and processing system 900 is illustrated. In some embodiments, a travel provider may monitor pricing; traveler offers; evaluate sales trends; projected demand; internal excess supply; filter by travel type, such as lodging or travel, as non-limiting examples, through a travel provider server system 950, which may comprise a travel provider server and a monitoring server. In some implementations, a monitoring and processing system 900 may comprise a travel provider aggregator 920, a traveler monitoring system 910, and a secondary travel provider server system 930 to improve and secure its monitoring capabilities. In some aspects, a traveler monitoring system 910 may comprise a traveler server that may store and process traveler profiles and a monitoring server that may monitor one or more of the travel provider server system 950, travel provider aggregator 920, and secondary travel provider server system 930.

In some aspects, a purchase server 940 may receive or initiate transactions between a traveler and a travel provider. In some embodiments, a travel provider may set conditional offers. In some implementations, a travel provider may set limited time offers. In some aspects, a traveler may submit an offer. In some embodiments, a travel provider may submit an offer to a group of travelers based on certain parameters, such as prior transaction history, travelers who submit offers equal to or higher than the travel provider's estimated offer, travelers who frequently travel to an offer location, travelers who express interest without listing a price, those who have a budget similar to a possible offer, or similar destinations to activities the traveler usually pursues, as non-limiting examples. For example, a traveler may normally go on vacation to a place with similar activities, such as a beach, tourist destination, or historical locations.

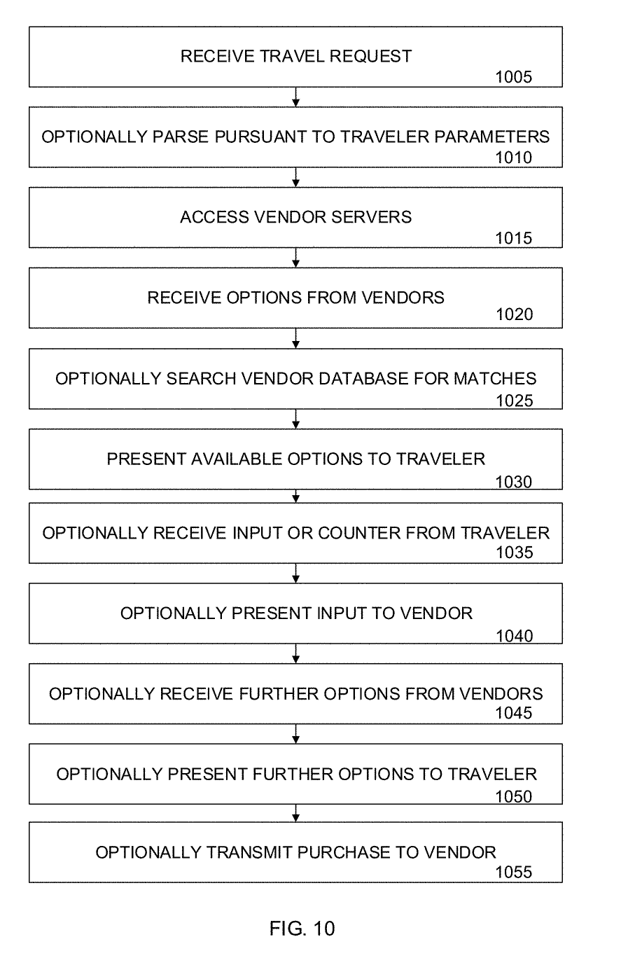

Referring now to FIG. 10, an exemplary process flowchart for receiving and conveying offers is illustrated. At 1005, a travel request may be received. In some embodiments, at 1010, traveler parameters may be parsed or filtered. At 1015, vendor servers may be accessed. At 1020, options may be received from vendors. In some implementations, at 1025, a vendor database may be searched for matches. At 1030, available options may be presented to the traveler. In some aspects, at 1035, a counteroffer or an input may be received from a traveler. In some embodiments, at 1040, a vendor may be presented with the new input or counteroffer. In some implementations, at 1045, a vendor may accept, reject, or counter. In some aspects, at 1050, further options may be presented to the traveler. In some embodiments, at 1055, a purchase may be transmitted to the vendor.

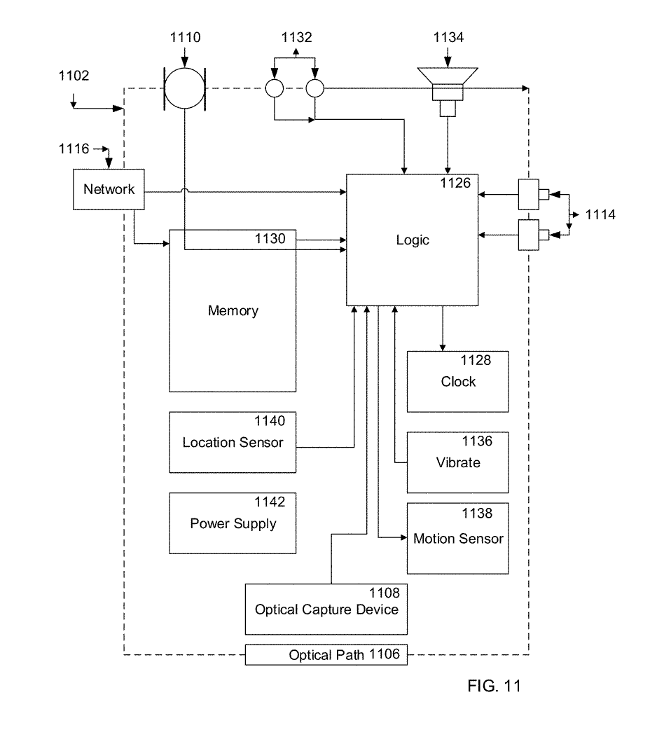

Referring now to FIG. 11, an exemplary block diagram of an exemplary embodiment of a mobile device 1102 is illustrated. The mobile device 1102 may comprise an optical capture device 1108, which may capture an image and convert it to machine-compatible data, and an optical path 1106, typically a lens, an aperture, or an image conduit to convey the image from the rendered document to the optical capture device 1108. The optical capture device 1108 may incorporate a Charge-Coupled Device (CCD), a Complementary Metal Oxide Semiconductor (CMOS) imaging device, or an optical sensor of another type.

In some embodiments, the mobile device 1102 may comprise a microphone 1110, wherein the microphone 1110 and associated circuitry may convert the sound of the environment, including spoken words, into machine-compatible signals. Input facilities 1114 may exist in the form of buttons, scroll-wheels, or other tactile sensors such as touch-pads. In some embodiments, input facilities 1114 may include a touchscreen display. Visual feedback 1132 to the user may occur through a visual display, touchscreen display, or indicator lights. Audible feedback 1134 may be transmitted through a loudspeaker or other audio transducer. Tactile feedback may be provided through a vibration module 1136.

In some aspects, the mobile device 1102 may comprise a motion sensor 1138, wherein the motion sensor 1138 and associated circuity may convert the motion of the mobile device 1102 into machine-compatible signals. For example, the motion sensor 1138 may comprise an accelerometer, which may be used to sense measurable physical acceleration, orientation, vibration, and other movements. In some embodiments, the motion sensor 1138 may comprise a gyroscope or other device to sense different motions.

In some implementations, the mobile device 1102 may comprise a location sensor 1140, wherein the location sensor 1140 and associated circuitry may be used to determine the location of the device. The location sensor 1140 may detect Global Position System (GPS) radio signals from satellites or may also use assisted GPS where the mobile device may use a cellular network to decrease the time necessary to determine location. In some embodiments, the location sensor 1140 may use radio waves to determine the distance from known radio sources such as cellular towers to determine the location of the mobile device 1102. In some embodiments these radio signals may be used in addition to and/or in conjunction with GPS.

In some aspects, the mobile device 1102 may comprise a logic module 1126, which may place the components of the mobile device 1102 into electrical and logical communication. The electrical and logical communication may allow the components to interact. Accordingly, in some embodiments, the received signals from the components may be processed into different formats and/or interpretations to allow for the logical communication. The logic module 1126 may be operable to read and write data and program instructions stored in associated storage 1130, such as RAM, ROM, flash, or other suitable memory. In some aspects, the logic module 1126 may read a time signal from the clock unit 1128. In some embodiments, the mobile device 1102 may comprise an on-board power supply 1142. In some embodiments, the mobile device 1102 may be powered from a tethered connection to another device, such as a Universal Serial Bus (USB) connection.

In some implementations, the mobile device 1102 may comprise a network interface 1116, which may allow the mobile device 1102 to communicate and/or receive data to a network and/or an associated computing device. The network interface 1116 may provide two-way data communication. For example, the network interface 1116 may operate according to an internet protocol. As another example, the network interface 1116 may comprise a local area network (LAN) card, which may allow a data communication connection to a compatible LAN. As another example, the network interface 1116 may comprise a cellular antenna and associated circuitry, which may allow the mobile device to communicate over standard wireless data communication networks. In some implementations, the network interface 1116 may comprise a Universal Serial Bus (USB) to supply power or transmit data. In some embodiments, other wireless links known to those skilled in the art may also be implemented.

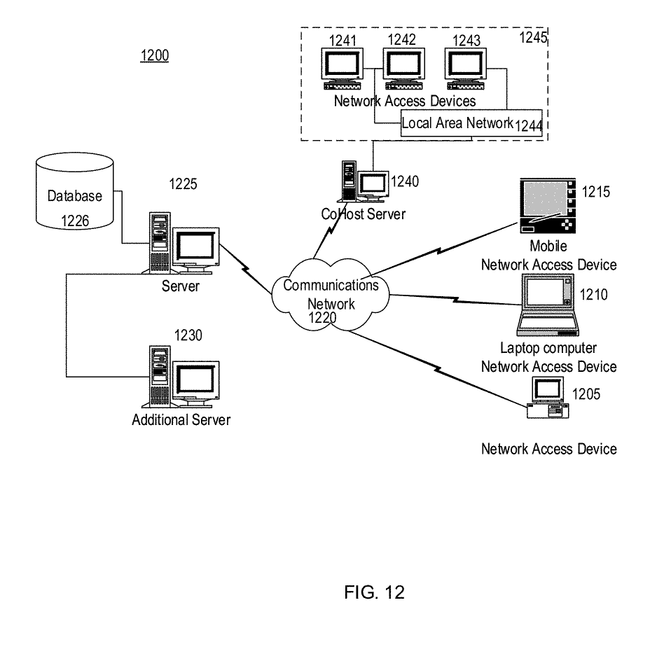

Referring now to FIG. 12, an exemplary processing and interface system 1200 is illustrated. In some aspects, access devices 1205, 1210, 1215, such as a paired portable device 1215 or laptop computer 1210 may be able to communicate with an external server 1225 though a communications network 1220. The external server 1225 may be in logical communication with a database 1226, which may comprise data related to identification information and associated profile information. In some embodiments, the server 1225 may be in logical communication with an additional server 1230, which may comprise supplemental processing capabilities.

In some aspects, the server 1225 and access devices 1205, 1210, 1215 may be able to communicate with a cohost server 1240 through a communications network 1220. The cohost server 1240 may be in logical communication with an internal network 1245 comprising network access devices 1241, 1242, 1243 and a local area network 1244. For example, the cohost server 1240 may comprise a payment service, such as PayPal or a social network, such as Facebook or Instagram or Snapchat or a dating website.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for executing travel transactions, comprising:
a traveler server configured to receive and store at least one traveler profile, wherein each traveler profile comprises:
at least one destination,
at least one travel type,
travel parameters comprising at least one travel date and duration,
price parameters comprising maximum price limits for one or more of the at least one travel type, travel parameters, and the at least one destination, and
traveler information comprising at least traveler identifying data;
a monitoring server configured to:
access the traveler server and a plurality of remote servers hosted by one or more travel vendors, wherein the one or more travel vendors offer at least a portion of the traveler profile,
periodically monitor the plurality of remote servers for availability data related to at least the portion of the traveler profile,
compare the price parameters to vendor pricing associated with the availability data related to at least the portion of the traveler profile,
identify qualified availability data paired with a qualified travel vendor and purchase information, wherein the vendor pricing associated with qualified availability data is priced equal to or below the price parameters related to at least the portion of the traveler profile, and
store qualified availability data.

2. The system of claim 1, wherein at least one traveler profile further comprises rank criteria, wherein the rank criteria prioritizes one or more of the plurality of destinations, at least one travel type, price parameters, and travel parameters, and the monitoring server is further configured to compare identified qualified availability data using rank criteria, wherein a comparison determines a best qualified availability data.

3. The system of claim 1, wherein the traveler server comprises purchaser information comprising at least purchaser identifying data and purchase authorization data, and wherein the system further comprises:
a purchase server configured to:
access the traveler server and monitoring server,
execute purchase of the best qualified availability data by transmitting purchaser information to the qualified travel vendor, and
transmit execution confirmation to one or more of the traveler server, monitoring server, purchaser, or traveler.

4. The system of claim 2, wherein the travel vendor comprises a travel aggregator.

5. The system of claim 2, wherein a ticket buying service operates one or more of the traveler server, the monitoring server, and the purchase server.

6. The system of claim 1, wherein the traveler profile further comprises destination activities.

7. The system of claim 1, wherein the monitoring server periodically monitors the plurality of remote servers.

8. The system of claim 7, wherein the monitoring server is further configured to monitor travel price trends associated with at least one traveler profile.

9. The system of claim 8, wherein the frequency of the periodic monitoring is based at least in part on a travel price trend associated with at least one traveler profile.

10. The system of claim 7, wherein at least one traveler profile comprises a monitoring parameter associated with one or more destination, travel type, and travel parameters, wherein the monitoring parameter determines the frequency of the periodic monitoring for the one or more destination, travel type, and travel parameters.

11. A system for executing travel transactions, comprising:
a travel provider server configured to:
access a traveler server, wherein the traveler server is configured to receive and store a plurality of traveler profiles, wherein each traveler profile comprises:
at least one destination,
at least one travel type,
travel parameters comprising at least one travel date and duration,
price parameters comprising maximum price limits for one or more of the at least one travel type, travel parameters, and the at least one destination, and traveler information comprising at least traveler identifying data;
filter traveler profiles by at least one offered travel type, wherein the travel provider server isolates relevant travel profiles, wherein relevant travel profiles comprise at least one offered travel type offered by the travel provider;
set a conditional offer for purchase of at least one offered travel type within offer travel parameters comprising an offer price and an offer duration;
identify target traveler profiles comprising the offered travel type within the offer travel parameters and price bids equal to or greater than the offer price; and
transmit the conditional offer to target travelers associated with target traveler profiles.

12. The system of claim 1, wherein the travel provider server is further configured to evaluate one or more sales trends, projected demand, and excess supply related to target criteria.

13. The system of claim 12, wherein the travel provider is further configured to access external servers comprising one or more vendor monitors, trend monitors, and traveler monitors.

14. The system of claim 1, further comprising a search server configured to:
receive at least one travel parameter search input;
access the travel provider server;
retrieve the conditional offer from the travel provider server;
compare the at least one travel parameter search input to the conditional offer, wherein the comparison determines whether the conditional offer comprises the at least one travel parameter search input;
return results of the comparison, wherein the returned results comprise the conditional offer if the conditional offer comprises the at least one travel parameter search input.

15. The system of claim 1, further comprising a plurality of travel provider servers, wherein each of the plurality of provider servers are configured to set a plurality of conditional offers.

16. The system of claim 1, further comprising a purchase server, wherein the purchase server is configured to:
transfer funds from a first account belonging to one or more of the target travelers to a second account belonging to the travel provider through an electronic transfer system.

17. The system of claim 16, wherein the purchase server is further configured to transfer a document confirming purchase of the target travel type to the one or more of the target purchasers.

18. The system of claim 1, wherein the transmission of the conditional offer occurs within the offer duration and the conditional offer expires after the offer duration.

19. The system of claim 1, wherein the traveler profile further comprises rank criteria, wherein the rank criteria prioritizes one or more of the plurality of destinations, at least one travel type, price parameters, and travel parameters, and the travel provider server is further configured to compare offer travel parameters to traveler profile using rank criteria.

20. The system of claim 19, wherein the offer travel parameters further comprise a rank threshold for one or more the travel type or destination, wherein target traveler profiles further comprise rank criteria equal to or lower than the rank threshold.
